(19) United States
(12) Patent Application Publication
(10) Pub. No.: US 2004/0084068 A1
(43) Pub. Date: May 6, 2004

(54) Dishwasher

(75) Inventors: Woon-Gu Hur, Suwon-City (KR); Sam-Young Jang, Yongin-City (KR); Tae-Young Jung, Hwasung-City (KR); Wang-Seok Son, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/437,935

(22) Filed: May 15, 2003

(30) Foreign Application Priority Data
Oct. 31, 2002 (KR) 2002-67206

(51) Int. Cl. B08B 3/02

(52) U.S. Cl. 134/58 D; 134/184; 134/200

(57) ABSTRACT

A dishwasher that is provided with an improved soundproofing structure to reduce the manufacturing cost of the dishwasher and accomplish an improved soundproofing effect in comparison with conventional dishwashers. The disclosed dishwasher includes a washing tub provided in a cabinet. A basket is provided in the washing tub to hold dishes therein. A washing pump pressurizes wash water contained in the washing tub. An injection nozzle sprays wash water supplied from the washing pump. A soundproofing unit with a net structure is installed in the washing tub in such a way as to be spaced apart from the inner surface of the washing tub, thus dispersing wash water sprayed from the injection nozzle while reducing pressure of the wash water.

### CROSS-REFERENCE TO RELATED APPLICATIONS

This application claims the benefit of Korean Application No. 2002-67206, filed Oct. 31, 2002, in the Korean Industrial Property Office, the disclosure of which is incorporated herein by reference.

### BACKGROUND OF THE INVENTION

1. Field of the Invention

The present invention relates, in general, to dishwashers and, more particularly, to a dishwasher which has an improved soundproofing structure.

2. Description of the Related Art

As is well known to those skilled in the art, a dishwasher is an appliance which is used to wash dishes by spraying high-pressure wash water onto the dishes. The dishwasher includes a cabinet. A washing tub is provided in the cabinet to define a washing space. A basket is installed in the washing tub in such a way as to slide in and out of the cabinet, and holds dishes therein. An injection nozzle is provided at the lower portion in the washing tub so as to spray wash water laden with a detergent onto the dishes held in the basket. A washing pump is connected to the injection nozzle to feed high-pressure wash water to the injection nozzle. The dishwasher also has a water supply unit, a drain unit, and a filtering means. In this case, the water supply unit functions to supply water into the washing tub. The drain unit functions to drain wash water from the washing tub after washing dishes. The filtering means functions to filter wash water so as to remove impurities from the wash water during a draining operation.

However, the conventional dishwasher washes dishes by spraying high-pressure wash water onto the dishes from the injection nozzle. Thus, the conventional dishwasher has a problem that a big noise is generated while washing dishes, because wash water sprayed from the injection nozzle strikes the inner surface of the washing tub. To minimize the noise generated during the washing operation, several techniques have been proposed. Asphalt may be coated on the outer surface of the washing tub to a predetermined thickness. Further, a soundproofing material which is a kind of insulating material may be applied to the outer surface of the washing tub. Such conventional soundproofing techniques, however, make the manufacture of dishwashers complicated, and thus undesirably increase the manufacturing cost of the dishwashers. In addition, the conventional soundproofing techniques do not effectively block noise, despite the considerable cost and efforts of the manufacturers.

### SUMMARY OF THE INVENTION

Accordingly, it is an aspect of the present invention to provide a dishwasher which has an improved soundproofing structure, thus reducing the manufacturing cost of dishwashers, and accomplishing an improved soundproofing effect in comparison with conventional dishwashers.

Additional aspects and advantages of the invention will be set forth in part in the description which follows and, in part, will be obvious from the description, or may be learned by practice of the invention.

The foregoing and/or other aspects of the present invention are achieved by providing a dishwasher, including a washing tub provided in a cabinet, a basket provided in the washing tub to hold dishes therein, a washing pump pressurizing wash water contained in the washing tub, an injection nozzle spraying wash water supplied from the washing pump, and a soundproofing unit of a net structure installed in the washing tub in such a way as to be spaced apart from an inner surface of the washing tub, thus dispersing wash water sprayed from the injection nozzle while reducing a pressure of the wash water.

According to an aspect of the present invention, the injection nozzle is installed at the lower portion in the washing tub so as to upwardly spray wash water, and the soundproofing unit is installed at an upper portion in the washing tub.

According to a further aspect of the invention, a door is mounted to a sidewall of the cabinet to open or close the washing tub, with a soundproofing unit being installed to an inner surface of the door and inner surfaces of sidewalls of the washing tub.

According to a still further aspect of the invention, a groove-shaped rail is provided on an inner surface of the washing tub to removably hold the frame of the soundproofing unit.

According to another aspect of the invention, an antibacterial material is coated on the net.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a sectional view illustrating a dishwasher according to an embodiment of the present invention;

FIG. 2 is a sectional view taken along the line II-II of FIG. 1;

FIG. 3 is a perspective view illustrating a soundproofing unit of the dishwasher of FIG. 1; and

FIG. 4 is a sectional view illustrating the soundproofing unit of the dishwasher of FIG. 1.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout. The embodiments are described below in order to explain the present invention by referring to the figures.

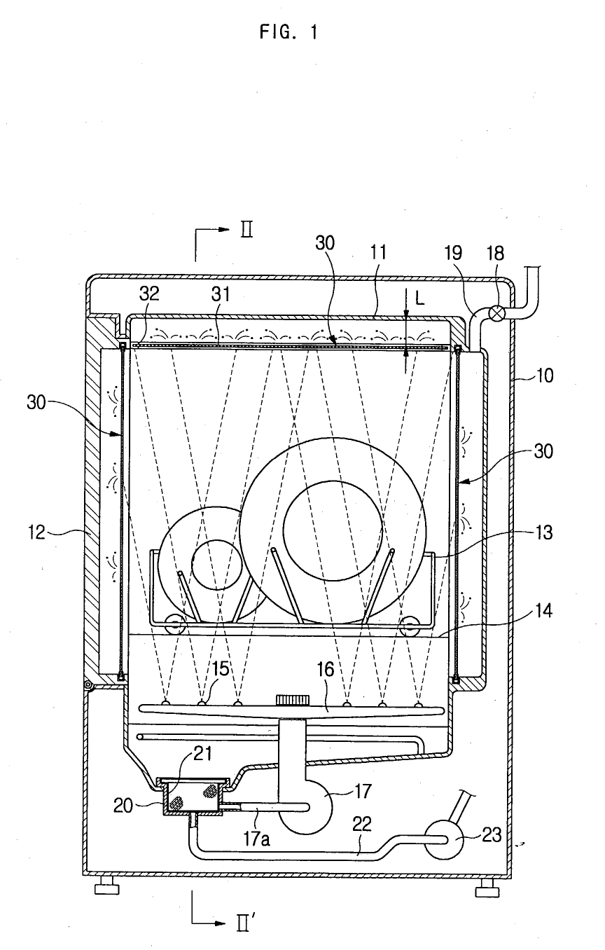

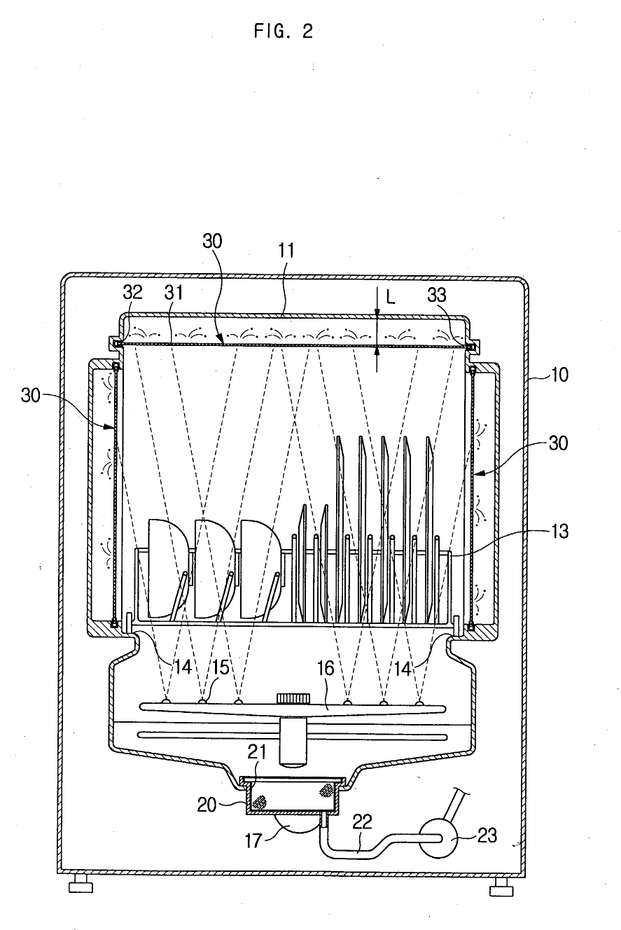

As illustrated in FIGS. 1 and 2, the dishwasher according to an embodiment of the present invention includes a cabinet 10. A washing tub 11 is set in the cabinet 10 to define a washing space. A door 12 is mounted to the sidewall of the cabinet 10 and rotates in a vertical direction about a horizontal axis so as to open or close the washing tub 11. A basket 13 is provided in the washing tub 11 and holds dishes therein. In this embodiment, the basket 13 is fabricated in the form of a wire net, and is supported by rails 14 in such a way as to easily slide in and out of the cabinet 10. The rails 14 are provided on opposite sidewalls of the washing tub 11.

An injection nozzle 16 is rotatably installed at the lower portion in the washing tub 11, and is provided with a plurality of injection holes 15 so as to spray wash water toward the basket 13. A washing pump 17 is installed at the lower portion of the washing tub 11, and functions to suck wash water from the washing tub 11, pressurize the wash water and feed the pressurized wash water to the injection nozzle 16.

A water supply pipe 19 is provided at the upper portion of the washing tub 11, and has a water supply valve 18 to feed wash water into the washing tub 11. A water container 20 is provided at the lower portion of the washing tub 11, and has a predetermined depth to collect wash water laden with impurities therein. A filter 21 is provided in the water container 20 to remove impurities from wash water. A suction pipe 17a of the washing pump 17 is connected to a predetermined portion of the water container 20 to allow wash water filtered by the filter 21 to recirculate in the washing tub 11. Further, a drain pipe 22 is connected to a predetermined portion of the water container 20 to drain wash water to the outside after washing dishes. A drain pump 23 is installed on the drain pipe 22 to forcibly drain wash water.

According to an embodiment of the present invention, the dishwasher is designed such that soundproofing units 30 (plates) are installed to the upper portion in the washing tub 11, the inner surfaces of sidewalls of the washing tub 11, and the inner surface of the door 12 . Thus, wash water sprayed from the injection nozzle 16 is prevented from directly striking the inner surfaces of the washing tub 11, thereby reducing generated noise.

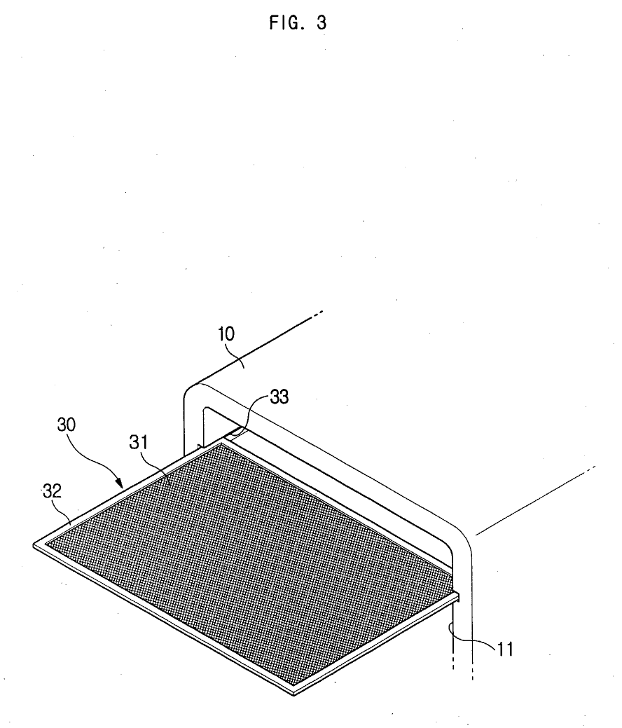

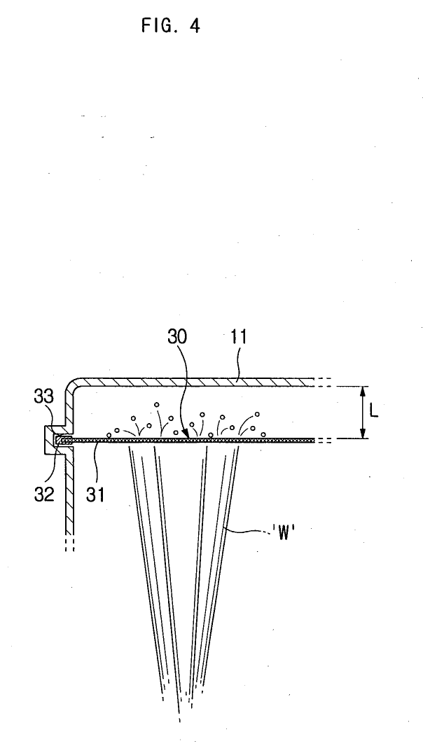

As illustrated in FIGS. 3 and 4, each of the soundproofing units 30 includes a net 31 and a frame 32. The net 31 covers an inner surface of the washing tub 11. The frame 32 supports an edge of the net 31. In an embodiment not illustrated, each soundproofing unit 30 may be installed so as to be directly adjacent to an inner surface of the washing tub 11. As illustrated in FIGS. 1 through 4, each soundproofing unit 30 is installed in the washing tub 11 so as to be spaced apart from an inner surface of the washing tub 11 by a predetermined interval L. In this embodiment, each soundproofing unit 30 is installed in the washing tub 11 by inserting the frame 32 of the soundproofing unit 30 into groove-shaped rails 33 which are provided on opposite inner surfaces of the washing tub 11, thus allowing the soundproofing unit 30 to be easily cleaned or replaced when necessary.

As illustrated in FIG. 4, when wash water W of a predetermined pressure sprayed from the injection nozzle 16 strikes the nets 31 of the soundproofing units 30, the wash water is dispersed while being reduced in pressure, thereby reducing noise generation due to the sprayed wash water. Thus, according to the embodiment of the present invention, soundproofing units 30 are installed in the washing tub 11 to reduce noise generated while washing dishes. This is different from conventional soundproofing techniques, where a soundproofing material, such as asphalt, is coated on the outer surface of a washing tub. This simplifies manufacturing and reduces the manufacturing cost of dishwashers.

Preferably, cells of the net 31 are compactly formed so as to have a small mesh capable of preventing impurities removed from dishes while washing the dishes from passing through the net 31, thus preventing the outer surface of the net 31 from becoming dirty due to the impurities. Further, the net 31 may be made of metal or resin, and has a predetermined strength and a desired corrosion resistance. An antibacterial material may be coated on the net 31, to prevent bacteria from being propagated on the net 31, and prevent mold from growing on the net 31 due to moisture in the dishwasher.

Operation of the dishwasher according to the illustrated embodiment of the present invention is described in the following.

First, detergent is put into the washing tub 11 and dishes to be washed are put in the basket 13. After sliding the basket 13 into the washing tub 11 and closing the door 12, the dishwasher is turned on. At this time, the water supply valve 18 opens so that wash water for washing dishes feeds into the washing tub 11.

When a predetermined amount of wash water is fed into the washing tub 11, the washing pump 17 operates to pressurize wash water laden with the detergent. The pressurized wash water is supplied to the injection nozzle 16 to spray wash water on the dishes held in the basket 13. Wash water having a predetermined pressure is sprayed from the injection nozzle 16 and the dishes held in the basket 13 are washed.

While washing the dishes, wash water is sprayed onto the dishes held in the basket 13 and a part of this wash water strikes the nets 31 of the soundproofing units 30 that are installed to the inner surfaces of the washing tub 11. When striking the nets 31, high-pressure wash water W is dispersed while being reduced in pressure. That is, since wash water W is not directly sprayed onto the inner surfaces of the washing tub 11, excessive noise is not generated. Wash water sprayed to wash the dishes is collected in the water container 20 which is provided at the lower portion of the washing tub 11. The wash water passes through the filter 21 so that impurities are removed from the wash water. Thereafter, clean wash water flows into the washing pump 17, and is again sprayed onto the dishes to wash dishes.

After performing a washing operation for a predetermined period of time, the drain pump 23 is operated to drain wash water with impurities to the outside. Next, the water supply valve 18 is once again opened to supply new wash water to the washing tub 11. When new wash water is supplied to the washing tub 11, a rinsing operation is performed in the same manner as the washing operation. After repeating the rinsing operation several times, wash water is completely drained by the drain pump 23. Thereafter, the dishwasher is stopped.

As apparent from the above description, the illustrated embodiment of the present invention provides a dishwasher, which is provided with a net-shaped soundproofing unit 30 installed in a washing tub 11 spaced apart from an inner surface of the washing tub 11, so that wash water W sprayed from an injection nozzle 16 is dispersed by the soundproofing unit 30 while being reduced in pressure prior to flowing down. Thus, preventing wash water W from being directly sprayed onto the inner surface of the washing tub 11 dramatically reduces noise caused by the sprayed wash water in comparison with conventional dishwashers.

The embodiment of the present invention provides a dishwasher that is designed such that a net-shaped soundproofing unit 30 is installed in a washing tub 11 so as to reduce noise generated while washing dishes. Due to the net-shaped soundproofing unit 30, the dishwasher is more easily manufactured and manufacturing costs are reduced, in comparison with dishwashers manufactured through conventional soundproofing techniques where a soundproofing material, such as asphalt, is coated on the outer surface of a washing tub.

In addition, according to an embodiment of the present invention, a soundproofing unit is designed such that cells of a net structure thereof are compactly formed, resulting in a small mesh capable of preventing the outer surface of the soundproofing unit from becoming dirty.

Further, according to an embodiment of the present invention, an antibacterial material is coated on a soundproofing unit, thus preventing bacteria from being propagated on the soundproofing unit.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A dishwasher, comprising:
a washing tub provided in a cabinet;
a washing pump, to pressurize wash water contained in the washing tub;
an injection nozzle to spray wash water supplied from the washing pump; and
a soundproofing unit installed in the washing tub.

2. The dishwasher as set forth in claim 1, wherein said soundproofing unit has a net structure.

3. The dishwasher as set forth in claim 1, wherein said soundproofing unit is installed in the washing tub so as to be spaced apart from an inner surface of the washing tub.

4. The dishwasher as set forth in claim 1, wherein:
said injection nozzle is installed at a lower portion in the washing tub so as to upwardly spray wash water; and
the soundproofing unit is installed at an upper portion in the washing tub.

5. The dishwasher as set forth in claim 1, further comprising a door mounted to a sidewall of the cabinet to open and close the washing tub wherein:
the soundproofing unit is installed to an inner surface of the door and an inner surface of a sidewall of the washing tub.

6. The dishwasher as set forth in claim 1, wherein said soundproofing unit comprises:
a net having a predetermined area to cover an inner surface of the washing tub; and
a frame to support an edge of the net.

7. The dishwasher as set forth in claim 6, further comprising a groove-shaped rail on an inner surface of the washing tub to removably hold the frame of the soundproofing unit.

8. The dishwasher as set forth in claim 6, further comprising antibacterial material coated on the net.

9. A dishwasher, comprising:
a washing tub;
an injection nozzle spraying wash water into the washing tub; and
a soundproofing unit provided on at least one inner surface of the washing tub.

10. The dishwasher as set forth in claim 9, wherein said soundproofing unit has a net structure, and is installed in the washing tub so as to be spaced apart from the inner surface of the washing tub.

11. A soundproofing system for a dishwasher comprising:
a washing tub;
an injection nozzle spraying wash water into the washing tub; and
a plate provided inside the washing tub to reduce water momentum.

12. The soundproofing system as set forth in claim 11, wherein the plate is spaced apart from an interior wall of the washing tub by a predetermined distance.

13. The soundproofing system as set forth in claim 11, wherein the plate is porous.

14. The soundproofing system as set forth in claim 11, wherein the plate is flexible.

15. The soundproofing system as set forth in claim 11, wherein the plate is coated with an antibacterial material.

16. The soundproofing system as set forth in claim 11, wherein the plate is removable.

17. The soundproofing system as set forth in claim 11, wherein the plate is positioned on an upper portion of the washing tub.

18. The soundproofing system as set forth in claim 11, wherein the plate is positioned on a door of the washing tub.

19. The soundproofing system as set forth in claim 11, wherein the plate is positioned on a side wall of the washing tub.

20. The soundproofing system as set forth in claim 11, wherein the plate is a small mesh capable of preventing impurities removed from a dish while washing the dish from passing through the plate.

21. The soundproofing system as set forth in claim 11, wherein the plate is fabricated from one of metal and resin and has a predetermined strength and a predetermined resistance to corrosion.

22. A dishwasher comprising:
a washing tub;
an injection nozzle; and
a soundproofing unit installed in the tub so that wash water sprayed from the injection nozzle is dispersed by the soundproofing unit.

23. The dishwasher of claim 22 wherein:
the soundproofing unit is net-shaped.

24. The dishwasher as set forth in claim 22, wherein:
the soundproofing unit is installed in the washing tub so as to be spaced apart from an inner surface of the washing tub.

25. A dishwasher comprising:
a washing tub;
an injection nozzle; and
a soundproofing unit installed in the tub so that the soundproofing unit prevents wash water sprayed from the injection nozzle from being sprayed directly onto an inner surface of the washing tub.

26. The dishwasher unit of claim 25 wherein: the soundproofing unit is net-shaped

27. The dishwasher as set forth in claim 25, wherein:
the soundproofing unit is installed in the washing tub so as to be spaced apart from the inner surface of the washing tub.
